(19) United States
(12) Patent Application Publication
(10) Pub. No.: US 2015/0209947 A1
(43) Pub. Date: Jul. 30, 2015

(54) DRIVE-IN DEVICE HAVING AN EFFECTIVE DRIVE

(71) Applicant: Hilti Aktiengesellschaft, Schaan (LI)

(72) Inventors: Roland Mandel, Lindau (DE); Klaus Bertsch, Feldkirch (AT)

(21) Appl. No.: 14/421,547

(22) PCT Filed: Aug. 13, 2013
(86) PCT No.: PCT/EP2013/066890

§ 371 Date: Feb. 13, 2015

(30) Foreign Application Priority Data
Aug. 17, 2012 (DE) 10 2012 214 625.3

(51) Int. Cl. B25F 5/00; B25C 1/06; F16H 3/72; F16H 3/00; F16H 63/04; F16H 9/08

(52) U.S. Cl. CPC B25F 5/001; F16H 63/04; F16H 9/08; F16H 3/728; F16H 3/003; B25C 1/06

(57) ABSTRACT

The invention relates to a drive-in device, comprising a handheld housing (20) having an energy transfer element accommodated therein for transferring energy to a fastening element, a driving apparatus for transporting the energy transfer element, at least one electric motor (480), and a gearing (401, 406) having an output shaft, wherein the driving apparatus can be driven by means of the electric motor (480) via the output shaft (404) of the gearing (401, 406), wherein at least one first gear ratio and one second gear ratio different from the first gear ratio, between a rotational speed of the motor (480) and a rotational speed of the output shaft (404), can be set by means of the gearing (401, 406).

The invention concerns a fastener driving device as in the generic part of claim 1.

Fastener driving devices in which a driving piston is tensioned via an electrical drive motor by means of a transmission and a spindle and is reset after a fastener driving operation are known from practice.

It is the problem of the invention to specify a fastener driving device that has an especially efficient drive.

For a fastener driving device of the kind mentioned at the start, this problem is solved in accordance with the invention with the characterizing features of claim 1. The rotary speed and the torque applied to the driving device can each be optimized according to need through the at least two different gear ratios. For instance, a tensioning of a mechanical energy storage element of the drive device in accordance with the required tensioning force can take place with a first gear at a low rotary speed of the output shaft, or with high torque. A resetting of the energy transmission element, for example by means of a motor turning in the opposite direction, can take place at a correspondingly different, second gear, where the rotary speed of the output shaft is high, but a high torque is not needed.

Through this, the time between two successive fastener driving operations can overall be minimized. Alternatively, if the cycle times remain unchanged, a smaller dimensioned motor can be provided in order to save cost or weight.

A fastener in the sense of the invention is understood to mean any drivable nail, bolt, or even a screw. The fastener driving device is electrically driven and hand held. The drive can preferably be provided via an electrical energy storage element based on a battery, in order to provide cordless operation.

The energy transmission element and the drive device can be designed in any way that is known for electrically powered fastener driving tools. For example, the energy transmission element can be a spring-loaded piston, which can be tensioned by a drive device comprising a rotatable spindle. The spring can be designed as a metal spring or even as a gas spring. In such tools, a tensioning of the spring takes place in most cases by rotating the spindle up to a tensioned state by means of an electrical motor. After a triggering operation, the piston is accelerated by the spring, so that a punch strikes the fastener and rubs the latter into a workpiece. A resetting of the piston to a starting position can then take place by additional rotation of the spindle, where the direction of rotation can be reversed in each case according to the design of the mechanical system.

It is provided in a preferred embodiment of the invention that the gear mechanism has at least two different, discrete switching steps. Discrete gear mechanisms of this kind are simple and can be made for small spaces, with little friction losses occurring. In an especially preferred detailed design, the gear mechanism has at least two output-side gears with different diameters, where the gears are permanently engaged with at least one drive-side gear, and where the output shaft can be coupled to one of the output-side gears as desired. This allows a variable ratio gear mechanism with only one more gear than in a fixed transmission. The selectable coupling of the output shaft to one of the gears can take place in a form fit or force fit, in each case according to requirements.

In an alternative embodiment of the invention, the gear mechanism is designed as a continuous gear mechanism. Such gear mechanisms are known in various designs, and are characterized by the fact that continuous or quasi-continuous change of the gear ratio can be selected at least over a range.

A first preferred detailed design of a continuously variable gear mechanism comprises at least two cones, which are connected with a transmission element. A different gear ratio is established in each case according to the position of the transmission element on the cones. Belts, chains, or other tensioning elements can serve as transmission elements. Examples of this are bevel crown gear mechanisms or V-belt adjustable gear mechanisms. In some designs, a force fit can also be made between a ring running between the cones as the transmission element.

In another embodiment of the invention, at least one second electrical motor is connected with the gear mechanism, where a rotary speed of the output shaft is dependent on the rotary speed of the at least two electrical motors. The gear mechanism in this case can, for example, be designed as a planetary gear mechanism. Such designs allow the rotary speed of the output shaft to result, in a simple way, as an arithmetic combination, for example addition or subtraction, of the motor speeds. The direction of rotation of each individual motor can also be reversible. Thus, all in all, gear modes with particularly high rotary speeds or particularly high torques on the output shaft become available.

In general, it is advantageously intended that the first gear ratio be present in the case of a first direction of rotation of the motor and that the second gear ratio be present in the case of an opposite direction of rotation of the motor. This enables simple optimization of the operation of the drive device. For example, in the case of the first direction of rotation and the first gear ratio, a spring element is tensioned, for which high torques and correspondingly low speeds are necessary. After the fastener setting operation, the energy transmission element is reset, which takes place with reversed rotation of the motor. Since high forces are not necessary for this, but on the other hand rapid resetting to increase the operating frequency is desirable, the said resetting takes place at the second gear ratio.

In a preferred further development, a control of the gear mechanism can take place via a carrier, which is braced against a driven shaft in a torque-limiting manner. Preferably, but not necessarily, this is the shaft of the motor. Such a control is reliable and efficient while additionally being realized cheaply.

Generally, however, a control of the gear mechanism can also take place in any other way. A control via an electromechanical actuator, a centrifugal clutch, a slip clutch, an overrunning clutch or a manually operatable actuator may be mentioned as examples but not limiting examples.

In one possible embodiment of the invention, the gear ratio of the gear mechanism can be changed over a process of a tensioning of the drive device. Through this, a homogeneous power takeoff from an energy storage element can take place and an operating frequency of the fastener driving device is further optimizable. Here one takes into account the fact that, in general, the required torque increases during the tensioning of a spring element in the drive device.

Alternatively or in addition, the gear ratio of the gear mechanism can also be changeable in dependence on a state of an electrical energy storage element. Through this, an operating frequency can be optimized on the basis of temperature, age, or selected size of a battery, in each case according to a residual charge and power capability.

Basically, all controls of the gear mechanism can take place through an electronic control of the fastener driving device, where the criteria for the selection of the gear ratio are present in correspondence with the relevant requirements.

Other features and advantages of the invention result from the embodiment examples and from the dependent claims. A number of preferred embodiment examples of the invention are described below and explained in more detail by means of the attached drawings.

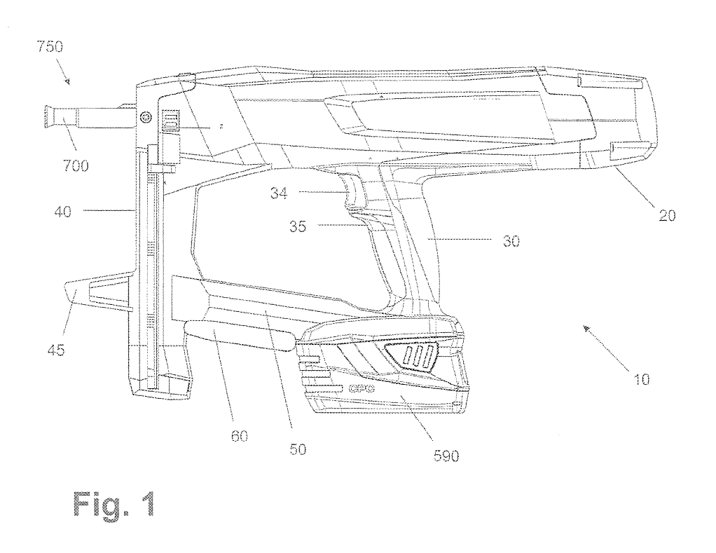

FIG. 1 shows a side view of a fastener driving device with a gear mechanism according to the prior art.

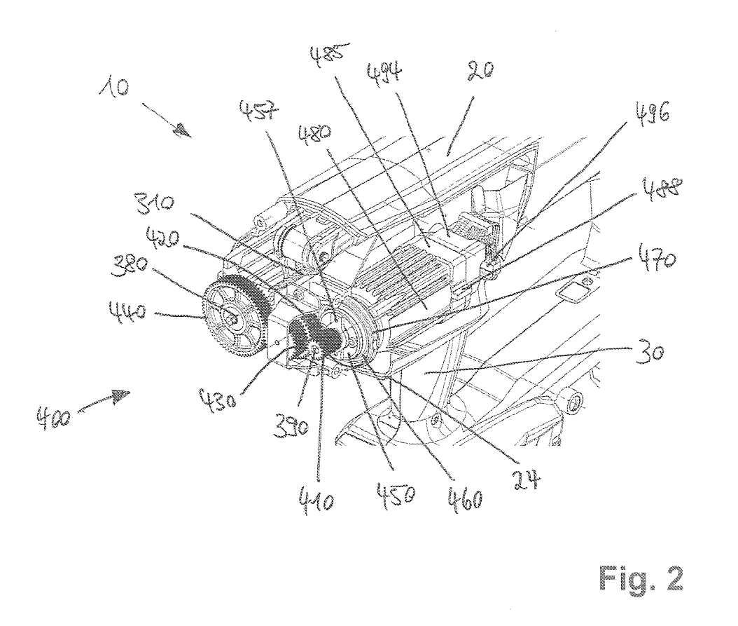

FIG. 2 shows a three-dimensional detailed view of a fastener driving device from FIG. 1, with the housing opened.

FIG. 3 shows a first embodiment of a gear mechanism for use in accordance with the invention in the fastener driving tool from FIG. 1.

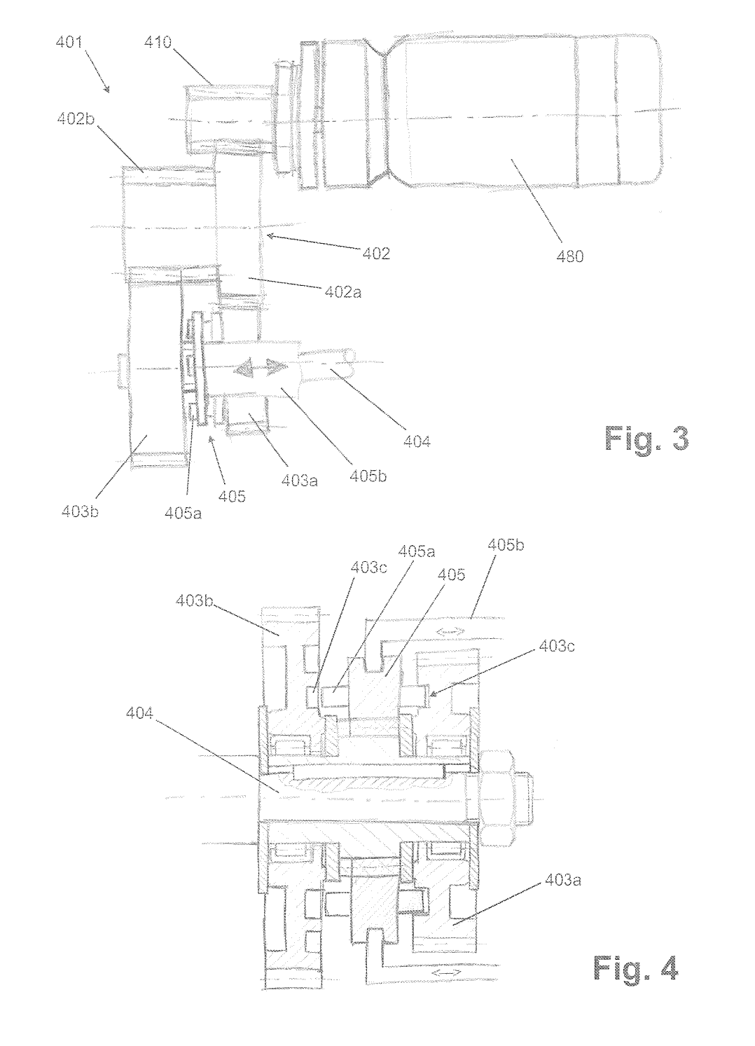

FIG. 4 shows an enlargement of a detail of the gear mechanism from FIG. 3.

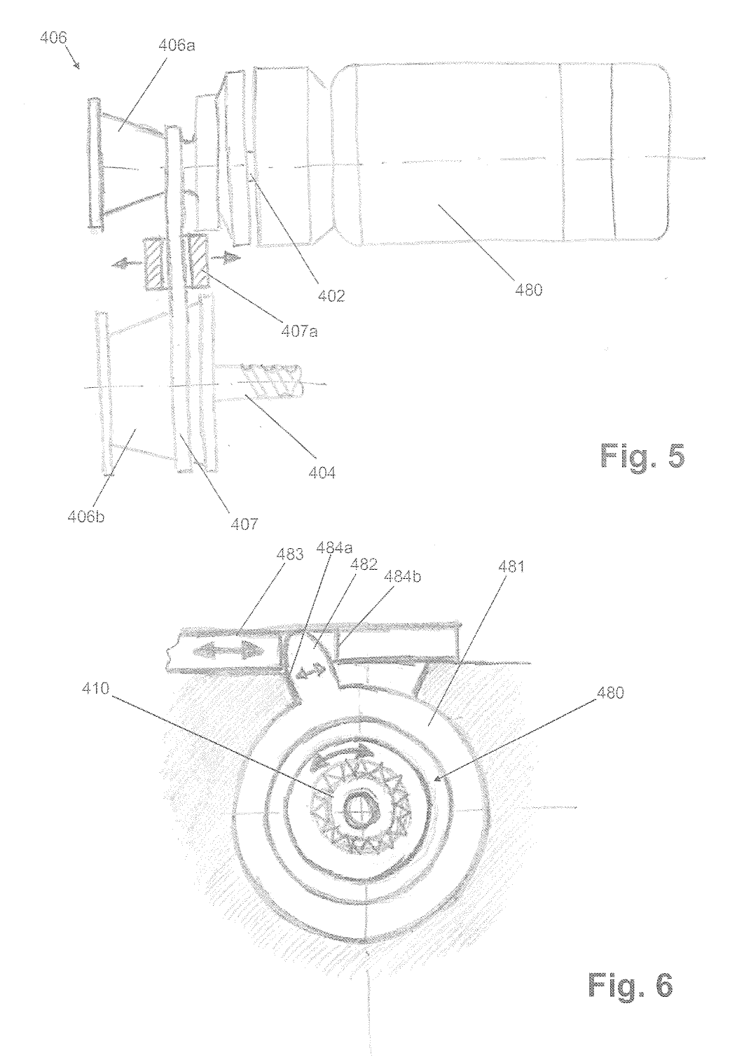

FIG. 5 shows a second embodiment of a gear mechanism for use in accordance with the invention in the fastener driving tool from FIG. 1.

FIG. 6 shows an automatic switching device of a fastener driving device in accordance with the invention.

FIG. 1 shows a fastener driving device 10 for driving a fastener, for example a nail or a bolt, into a substrate, in a side view. The fastener driving device 10 has an energy transmission element, not shown, for transmission of energy to the fastener, and a housing 20, in which the energy transmission element and a drive device, also not shown, for transport of the energy transmission element are accommodated.

The fastener driving device 10 further has a handle 30, a magazine 40, and a bridge 50 connecting the handle 30 to the magazine 40. The magazine is not removable. A scaffold hook 60 for hanging the fastener driving device 10 to a scaffold or the like and an electrical energy storage element designed as a battery 590 are affixed to the bridge 50. A trigger 34 and a grip sensor designed as a hand switch 35 are disposed on the handle 30. In addition, the fastener driving device 10 has a guide channel 700 for guiding the fastener and a pressure device 750 for detecting a distance of the fastener driving device 10 from a substrate, which is not shown. Aligning the fastener driving device perpendicular to a substrate is supported by an alignment aid 45.

FIG. 2 shows the fastener driving device 10 in another partial view. The housing 20 has the handle 30 and the motor housing 24. The motor 480 with the motor mount 485 is accommodated in the motor housing 24, which is only partly shown. The motor pinion 410 with the rotor recess 457 and the retention device 450 sit on the motor output of the motor 480.

The motor pinion 410 drives gears 420 and 430 of a torque transmission device designed as gear mechanism 400. The gear mechanism 400 transmits a torque of the motor 480 to a spindle gear 440, which is mounted without the possibility of rotation on a rotary drive of a motion converter, which is not further shown, the rotary drive being designed as a spindle 310. The gear mechanism 400 has a gear reduction so that a greater torque is exerted on the spindle 310 than on the motor output 390. The motor pinion 410 and gears 420 and 430 are preferably made of a metal, an alloy, steel, a sintered metal, and/or in particular fiber-reinforced plastic.

In order to protect the motor 480 against large accelerations, which arise in the fastener driving device 10, in particular in the housing 20, during a fastener driving operation, the motor 480 is decoupled from the housing 20 and the spindle drive. Since an axis of rotation 390 of the motor 480 is oriented parallel to a setting axis 380 of the fastener driving device 10, a decoupling of the motor 480 in the direction of the axis of rotation 390 is desirable. This is brought about by the motor pinion 410 and the gear 420, which is driven directly by the motor pinion 410, being slidably disposed with respect to each other in the direction of the setting axis 380 and the axis of rotation 390.

The motor 480 is thus affixed to the mounting element 470, which is solidly mounted on the housing, and thus to the housing 20 only via the motor damping element 460. The mounting element 470 is prevented from rotating in a corresponding counterpart contour of the housing 20 by means of a notch. In an embodiment example that is not shown, the mounting element is prevented from rotating in a corresponding counterpart contour of the housing by means of a lug. Moreover, the motor is slidably mounted only in the direction of its axis of rotation 390, namely via the motor pinion 410 on the gear 420 and via a guide element 488 of the motor mount 485 on a correspondingly shaped motor guide of the motor housing 24, which is not shown.

Other elements that are shown are strain relief elements 494 and 496 and a guide element 488 of the motor mount 485.

The fastener driving device described above corresponds to the prior art, where the installed gear mechanism 400 has a constant, invariable ratio. Gear mechanisms and their details that are installed in the fastener driving device 10 in place of the traditional gear mechanism 400 are described below; through these gear mechanisms, a fastener driving device in accordance with the invention is obtained in each case.

FIG. 3 shows a gear mechanism 401, which is connected to the motor 480 via the motor pinion 410. Here an input-side gear shaft 402 with a first sprocket wheel 402a engages with the motor pinion 410, and in addition a second sprocket wheel 402b that is smaller in diameter is situated on the gear shaft 402. The gear mechanism shown in FIGS. 3 and 4 is a manual gear mechanism with two different ratios.

The first sprocket wheel 402a permanently engages with a first, rotatably mounted gear 403a, and the second sprocket wheel 402b engages with a second, rotatably mounted gear 403b. The gears 403a and 403b are mounted separate from each other, but on the same axis. The second gear 403b is larger than the first gear 403a, so that, all in all, the second [sic; first] gear 403a has a higher gear ratio, or runs more slowly for a given motor speed than the second gear 403b. The gear ratio is in this case defined as the ratio of a drive speed to a driven speed.

An output shaft 404 of the gear mechanism 401 can now be selectably engaged with the first gear 403a or with the second gear 403b. For this, a gear mechanism coupling sleeve 405 is shifted along the common axis of the gears 403a and 403b until the axial projections 405a of the coupling sleeve 405 engage with the relevant recesses 403c in the side walls of the gears 403a and 403b in a form fit. Moreover, the gear mechanism coupling sleeve 405 engages in the direction of rotation with the output shaft 404, on which it moreover is slidably mounted.

The shifting of the gear mechanism coupling sleeve 405 takes place via a selector fork 405b, which is connected with a switch control, which can be designed in any way.

Thus, in each case, according to the switch position of the gear mechanism coupling sleeve 405, either the rotary speed of the first gear 403a or the rotary speed of the second gear 403b is transmitted to the output shaft 404. In each case, according to the detailed design, the output shaft 404 can be connected with other gear mechanism elements or even directly with the spindle 310 of the drive device.

In this way, in the first switch setting with fast rotation of the output shaft 404, the energy transmission element (piston, driving ram) can be retracted to a starting position after a fastener driving operation. Subsequently, the gear mechanism is switched to the second switch setting, so that a spring element is tensioned via a low rotary speed at high torque, via the spindle 310.

In the embodiment example in FIG. 5, there is a continuously variable gear mechanism 406, in which any desired ratio can be established within a certain interval. Such a gear mechanism, similar to the gear mechanism 401 described above, can be used with the fastener driving tool from FIG. 1 instead of the traditional gear mechanism with fixed ratio that is shown there.

The gear mechanism 406 has a first cone 406a, which is disposed on a motor shaft of the motor 480 without the possibility of rotation on the shaft. The motor shaft in this case forms the input-side gear shaft 402.

A second cone 406b is disposed without the possibility of rotation on an output shaft 404 of the gear mechanism 406, where the input-side gear shaft 402 and the output shaft 404 run parallel to each other.

An endless tensioning means 407 runs around the two cones 406a and 406b, so that the rotary motion of the first cone 406a is transmitted to the second cone 406b. The tensioning means can, for example, be a drive belt.

A guide 407a of the tensioning means 407 is slidable parallel to the gear shafts 402 and 404 and establishes a position of the encircling tensioning means 407 in the axial direction. The cones 406a and 406b are designed and positioned so that at any axial position of the tensioning means 7, they result in the same circumference for the tensioning means. Through this, the gear ratio can be continuously changed. In accordance with FIG. 5, a maximum ratio is present at a right limit stop of the guide 407a, so that a maximum torque is transmitted via the output shaft 404 at minimum speed.

The control of the gear mechanism takes place through the axial sliding of the guide 407. This can take place electromechanically, by means of a centrifugal force arrangement, manually, or in any other appropriate way.

The gear mechanism shown in FIG. 5 can have any desired modifications. The drive gears of the cones 406a and 406b can be connected to the motor shaft and/or drive device via other transmissions. The tensioning means can also be guided between the cone pairs, as, is common in the continuously variable automatic transmissions of mopeds, for example. The exact layout of the continuous variable gear mechanism is chiefly dependent on the power to be transmitted and the required lifespan.

FIG. 6 shows an example of a particularly simple and efficient control for a variable ratio gear mechanism. The motor 480 with its housing 481 is mounted rotatably about a limited angle with respect to the housing of the fastener driving device, where a control element 482 is disposed on the motor housing. The control element 482 is in this case designed as a simple lug, which engages with a slide 483. The slide 483 can, for example, be connected via a linkage to the switching fork 405b of the gear mechanism from FIG. 3.

The rotatable recess of the motor housing leads to the positioning element 482 being pressed against a first stop 484a in a startup of the motor. If the motor is started in the reverse direction of rotation, a correspondingly directed torque is exerted on the motor housing 481 via the motor pinion 410, so that the motor housing rotates by the limit angle until the positioning element 482 reaches a second stop 484b. In doing so, the slide 483 is shifted by one stroke, through which a switching or control of a gear mechanism takes place.

In the case of the example of the combination of control from FIG. 6 with the gear mechanism from FIG. 1, it can be achieved in a simple way that another gear ratio is selected automatically in the different directions of rotation of the motor.

1. A fastener driving device, comprising a hand held housing with an energy transmission element accommodated therein for transmission of energy to a fastener; a drive device for transport of the energy transmission element; at least one electrical motor; and a gear mechanism with an output shaft, wherein the driving device is driven by the electrical motor via the output shaft of the gear mechanism; and at least one first gear ratio and one second gear ratio, wherein the first gear ration is different than the second gear ratio, and the first gear ration and the second gear ration can be established between a rotary speed of the motor and a rotary speed of the output shaft by the gear mechanism.

2. The fastener driving device as in claim 1, wherein the gear mechanism has at least two different, discrete switching steps.

3. The fastener driving device as in claim 2, wherein the gear mechanism has at least one drive-side gear, and at least two output-side gears having different diameters, where the output-side gears permanently engaged with the drive-side gear, and where the output shaft is selectably coupleable to one of the output-side gears.

4. The fastener driving device as in claim 1, wherein the gear mechanism is a continuously variable gear mechanism.

5. The fastener driving device as in claim 4, wherein the gear mechanism comprises at least two cones, which are connected by a transmission element.

6. The fastener driving device as in claim 1, wherein at least one second electric motor is connected with the gear mechanism, where a rotary speed of the output shaft is dependent on the rotary speeds of the at least two electric motors.

7. The fastener driving device as in claim 6, wherein the drive mechanism is a planetary drive mechanism.

8. The fastener driving device as in claim 1, wherein the first gear ratio is present at a first rotary direction of the motor, and the second gear ratio is present at an opposite direction of rotation of the motor.

9. The fastener driving device as in claim 8, wherein a control of the gear mechanism takes place via a carrier, which is supported in a torque transmitting manner against a driven shaft.

10. The fastener driving device as in claim 1, wherein a control of the gear mechanism takes place via an electromechanical actuator, a centrifugal force clutch, a slip clutch, an overrunning clutch, or a manually operated control element.

11. The fastener driving device as in claim 1, wherein the gear ratio of the gear mechanism can be changed via tensioning of the driving device.

12. The fastener driving device as claim 1, wherein a gear ratio of the gear mechanism can be changed depending on a state of an electrical energy storage element.

13. The fastener driving device as in claim 2, wherein at least one second electric motor is connected with the gear mechanism, where a rotary speed of the output shaft is dependent on the rotary speeds of the at least two electric motors.

14. The fastener driving device as in claim 3, wherein at least one second electric motor is connected with the gear mechanism, where a rotary speed of the output shaft is dependent on the rotary speeds of the at least two electric motors.

15. The fastener driving device as in claim 4, wherein at least one second electric motor is connected with the gear mechanism, where a rotary speed of the output shaft is dependent on the rotary speeds of the at least two electric motors.

16. The fastener driving device as in claim 5, wherein at least one second electric motor is connected with the gear mechanism, where a rotary speed of the output shaft is dependent on the rotary speeds of the at least two electric motors.

17. The fastener driving device as in claim 13, wherein the drive mechanism is designed as a planetary drive mechanism.

18. The fastener driving device as in claim 14, wherein the drive mechanism is a planetary drive mechanism.

19. The fastener driving device as in claim 15, wherein the drive mechanism is a planetary drive mechanism.

20. The fastener device as in claim 9, wherein the carrier is supported in a torque transmitting manner against a driven shaft of the motor.
